(19) United States
(12) Patent Application Publication
(10) Pub. No.: US 2019/0149475 A1
(43) Pub. Date: May 16, 2019

(54) UNIFIED STREAMLINING FOR DATA TRAFFIC

(71) Applicant: INSPEED NETWORKS, INC., LOS ALTOS, CA (US)

(72) Inventor: KEVIN MARTIN, MENLO PARK, CA (US)

(21) Appl. No.: 16/188,459

(22) Filed: Nov. 13, 2018

Related U.S. Application Data
(60) Provisional application No. 62/585,870, filed on Nov. 14, 2017.

(51) Int. Cl. H04L 12/851; H04L 12/801; H04L 12/825; H04L 12/46

(52) U.S. Cl. CPC H04L 47/24; H04L 12/4633; H04L 47/25; H04L 47/12

(57) ABSTRACT

As an example, a node includes a first link to connect a first network and a second link to connect to a second network. A virtual interface coupled between the first link and the second link and residing in a communications path for data traffic between the first network and the second network. An instance of a dynamic traffic controller that controls the virtual interface to apply receive streamlining to data packets received from the first network and provide streamlined data packets to the second network via the second link based on the receive streamlining. The receive streamlining establishes a priority for receiving the data packets from the first network for sending the received data packets based on prioritization rules and controls congestion of the data traffic received from the first network by adjusting a rate limit of the virtual interface for the data traffic received from the first network based on a measure of bandwidth for the first network.

### CROSS-REFERENCE TO RELATED APPLICATION

This application claims the benefit of priority from U.S. Provisional Application No. 62/585,870, filed Nov. 14, 2017, and entitled UNIFIED STREAMLINING FOR DATA TRAFFIC, which is incorporated herein by reference in its entirety.

### TECHNICAL FIELD

This disclosure relates generally to unified streamlining of data traffic.

### BACKGROUND

Bottlenecks tend to occur in various places of communication networks, such as at internet service provider (ISP) links as well as in other network paths. For instance, a local network path that passes through a lower speed node has a bottleneck at such node. An example of such a bottleneck would be a gigabit (1000 Mbps) network passing through a 100 Mbps switch. Paths with bottlenecks can also occur in the internet, such as at peering points (internet exchange points) where ISP policies restrict the rate of transit traffic.

### SUMMARY

This disclosure relates to unified streamlining of data traffic.

As one example, a node includes a first link to connect a first network and a second link to connect to a second network. A virtual interface coupled between the first link and the second link and residing in a communications path for data traffic between the first network and the second network. An instance of a dynamic traffic controller that controls the virtual interface to apply receive streamlining to data packets received from the first network and provide streamlined data packets to the second network via the second link based on the receive streamlining. The receive streamlining establishes a priority for receiving the data packets from the first network for sending the received data packets based on prioritization rules and controls congestion of the data traffic received from the first network by adjusting a rate limit of the virtual interface for the data traffic received from the first network based on a measure of bandwidth for the data traffic. In some examples, the node also may apply transmit streamlining to data packets being from the second network and provide streamlined data packets to the first network.

As another example, a method includes receiving, at a node, data traffic from a first network via a first link of the node that is connected to the first network. The node resides in a communications path for the data traffic between the first network and a second network. The method also includes controlling a virtual interface of the node, which is coupled between the first link and a second link connected to the second network, to execute receive streamlining on each data packet in the data traffic received from the first network. The receive streamlining establishes a priority for sending the data packets received from the first network to the second network based on prioritization rules. The receive streamlining also controls congestion of the data traffic received from the first network by adjusting a rate limit of the virtual interface for the data traffic received from the first network via the first link based on a measure of bandwidth for the first network. The method also includes providing streamlined data packets from the virtual interface to the second network via the second link based on the receive streamlining. In some examples, the method further may include controlling the same or different virtual interface of the node to execute transmit streamlining on data packets received at the node from the second network.

### BRIEF DESCRIPTION OF THE DRAWINGS

FIG. 1 depicts an example of a node connected between networks to perform streamlining to network data traffic.

FIG. 2 depicts an example of a node connected between networks to perform receive streamlining and transmit streamlining to network data traffic.

FIG. 3 depicts another example of a node that includes corresponding virtual interfaces connected between networks to perform receive streamlining and transmit streamlining to network data traffic.

FIG. 4 depicts yet another example of a node that includes corresponding virtual interfaces connected between networks to perform receive streamlining and transmit streamlining to network data traffic.

FIG. 5 depicts an example of a node connected between networks to perform receive streamlining and transmit streamlining to tunnel data traffic.

FIG. 6 depicts an example of a node connected between networks to perform receive streamlining and transmit streamlining to both tunnel and bypass data traffic.

FIG. 7 depicts an example of a node implemented as code executing in a computer device to apply streamlining to network data traffic.

FIG. 8 is a flow diagram depicting an example of a method to perform streamlining to network data traffic.

### DETAILED DESCRIPTION

This disclosure relates to a node that is configured to perform streamlining of data traffic in a network path. For example, the node includes a virtual interface, configured to perform prioritization and congestion management that passes through a bottleneck on a network path that includes the node. The virtual interface performs streamlining to improve the quality of traffic through the network path containing the bottleneck. As used herein, receive streamlining refers to streamlining that is performed by the virtual interface on traffic that is received by the node from a corresponding network. Transmit streamlining refers to streamlining that is performed by the virtual interface before transmitting the traffic to the corresponding network. Thus, the streamlining is performed on data traffic communicated between the virtual interface and the corresponding network. For example, the node can be configured to implement receive streamlining of data traffic that is received from an external network. Alternatively, the node can be configured to implement both receive streamlining to the data traffic that is received from the external network and transmit streamlining to data traffic that is being transmitted from the node to the external network.

As an example, for both transmit and receive streamlining, a dynamic traffic controller is configured control a virtual interface, residing in a path between networks, to perform a prioritization method and congestion management. The prioritization method employs prioritization rules to control a priority of data traffic so that higher priority data traffic (e.g., interactive media, such as voice, video conferencing or other user-defined traffic) is given precedence over lower, other priority traffic. The congestion management function adjusts a rate limit of traffic through the virtual interface (e.g., in the receive direction or transmit direction) such as until the bottleneck occurs in the node and no longer in the network path that is external to the node. In some circumstances, data packets may be discarded to avoid creating buffer bloat within the node. By adjusting the rate limit within the node to be just below the bottleneck of the external network path, the virtual interface enables the external network to implement transport protocol functions to adjust network bandwidth. Thus, the rate limiting function of the virtual interface can cooperate with and facilitate data traffic and bandwidth controls implemented by the external network.

In some examples, a tunnel can be configured between the virtual interface and the external network to encapsulate data traffic that is communicated between the virtual interface and one or more endpoints in the external network. The streamlining that is performed by the virtual interface may be applied to the tunnel, such that only tunnel traffic is streamlined. In other examples where a data path is provided to bypass the tunnel, the virtual interface can be configured to implement streamlining with respect to both bypass traffic and tunnel traffic.

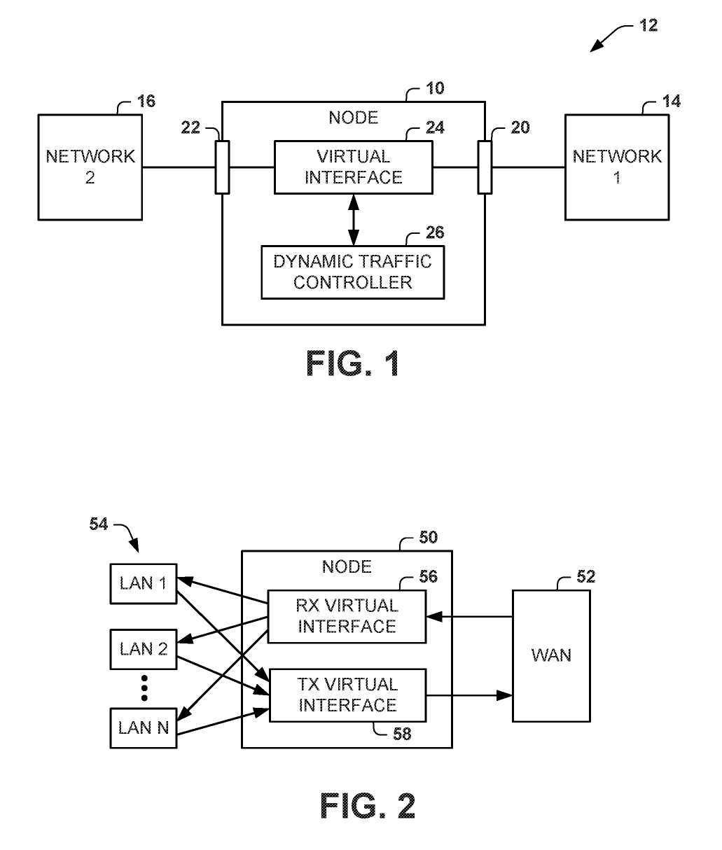

FIG. 1 depicts an example of a node 10 in a data communication system 12. The node 10 is computing device configured to control data traffic that is communicated along a network path between a first network 14 and a second network 16. The first and second networks 14 and 16 may be include any type of data communications networks that employ transmission media (wired technologies, wireless technologies) and various network building blocks (e.g., network interface controllers, repeaters, hubs, bridges, switches modems, etc.) to interconnect other network nodes within each respective network. The networks 14 and 16 may be part of the same network or different networks. While in the example of FIG. 1, the node 10 is in the path for data traffic between two networks 14 and 16, it is understood that the node 10 can be connected be any number of one or more networks and network paths that may exist between such networks. That is each network 14 and 16 may include one or more interconnected networks.

As an example, the first network 14 can be implemented as a wide area network (WAN), such as the internet, and the second network 16 can include one or more local area networks associated with a premise or enterprise network. Alternatively, the second network can correspond to an internet backbone or other type of network topology. Thus, each of the networks 14 and 16 can implement circuitry to communicate using one or more physical layer, such as optical fiber networks, electrically conductive networks and/or wireless networks, and implement one or more corresponding data link layers to provide for communication of data traffic according to the physical layer(s) that is used.

In some examples, the network path where the node 10 resides in the network path corresponds to a place where a bottleneck may occur for data traffic between the first and second networks 14 and 16. For example, bottlenecks may occur in an internet service provider (ISP link) or a path that passes through a lower speed node such as a gigabit (1000 Mbps) network passing through a 100 Mbps switch. Paths with bottlenecks can also occur in the internet, such as at peering points where ISP policies may restrict the rate of transit traffic from one provider to another. Examples of peering points where bottlenecks may occur can include cloud-to-cloud traffic, cloud-to-premise traffic, premise-to-cloud traffic or premise-to-premise traffic. The node 10 thus may be located at or near any such bottleneck or in a network path that includes the bottleneck.

The node 10 thus is a hardware device that includes one or more processors and memory configured to control data traffic along a network path between the networks 14 and 16, such as disclosed herein. The node 10 includes a link 20 to connect the node with the first network 14 and another link 22 to connect the node with the second network 16. Each of the links 20 and 22 can be implemented as a network interface controller (NIC) that implements electronic circuitry to provide for communication via each respective network using a specified physical layer and data link layer standard according to the requirements of each network 14 and 16. The link thus includes computer hardware that provides the node 10 with the ability to access the transmission media of the network 14 or 16, and to process low-level network information. For example, the node may include any number of NICs, each having one or more connectors (ports) for accepting a cable (e.g., electrically conductive wires and/or optical fiber) or an antenna for wireless transmission and reception, and the associated circuitry.

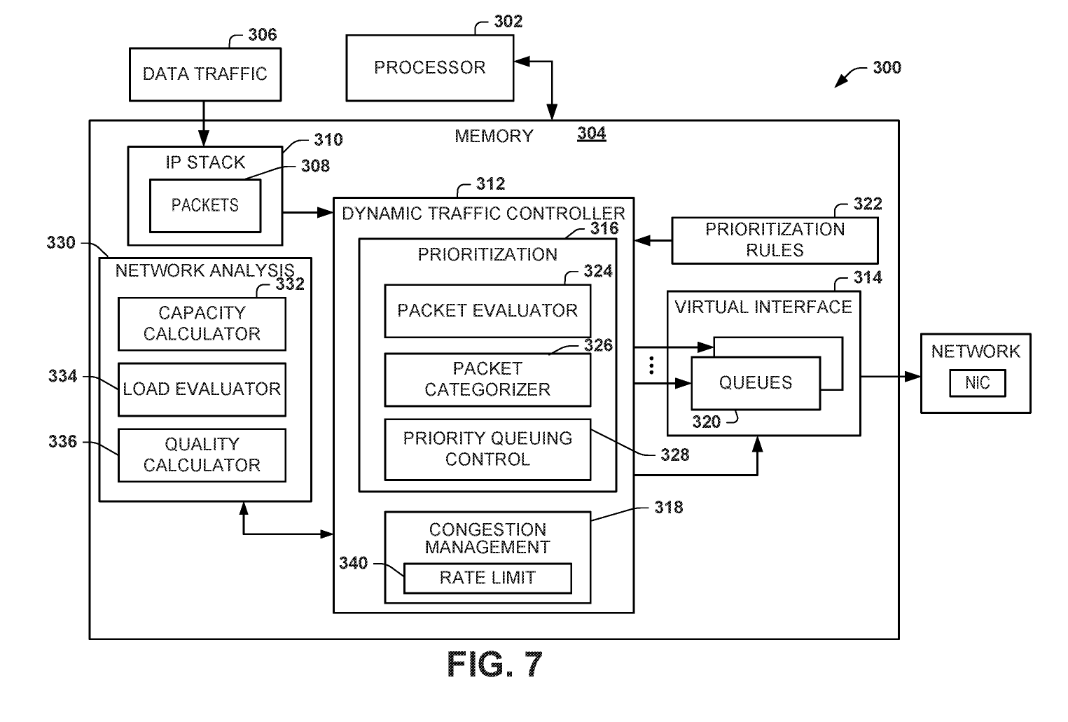

The node 10 includes a virtual interface 24 connected between each of the respective links 20 and 22. The node 10 also includes a dynamic traffic controller 26 that controls the virtual interface 24 to implement the streamlining on data packets that are communicated between the virtual interface 24 and the network 14 via the link 20. The dynamic traffic controller 26 controls the virtual interface 24 to implement streamlining of data traffic between the virtual interface and one of the links 20 and 22 by applying prioritization and congestion management to data packets that are communicated over the network path in which the node resides. The prioritization method and congestion management method implemented by the virtual interface 24 is described herein with respect to FIG. 7.

As one example, the dynamic traffic controller 26 controls the virtual interface 24 to execute receive streamlining on data packets received from the network 14 and to route the streamlined data packets to the other network 16 via the link 22. The receive streamlining establishes a priority for sending the data packets received from the first network 14 to the second network based on prioritization rules and controls congestion of the data traffic received from the first network 14 by adjusting the rate limit of the virtual interface 24 for the data traffic that is received from the first network based on a measure of bandwidth for the data traffic between the network 14 and the node. In the following examples, the virtual interface 24 applies streamlining to data traffic that is communicated between the virtual interface 24 and the network 14 via the link 20.

Additionally, in some examples, the dynamic traffic controller 26 controls the virtual interface 24 to execute transmit streamlining on data packets transmitted from the node 10 to the first network 14 via the link 20. Similar to receive streamlining, the transmit streamlining establishes a priority for transmitting the data packets from the node to the first network based on the prioritization rules. The dynamic traffic controller 26 further controls the virtual interface 24 to perform congestion management by adjusting a rate limit of the virtual interface 24 for the data traffic that is being transmitted from the node to the first network 14 based on the measure of bandwidth for the data traffic.

By way of further example, the link 20 thus includes one more ports for receiving ingress traffic at the node 10 from the network 14 and/or includes one or more other ports for sending egress traffic from the node 10 to the network 14. Similarly, the link 22 includes one more ports for receiving ingress traffic at the node 10 from the network 16 and/or includes one or more other ports for sending egress traffic from the node 10 to the network 16. Accordingly, the data flow between network 14 and link 20 and between network 16 and link 22 may be in one direction or both directions, namely, ingress and/or egress data.

In some examples, the dynamic traffic controller 26 controls the virtual interface 24 to implement congestion management that results in one or more data packets being dropped and discarded based on measured capacity of the network 14. Thus, as part of the receive streamlining, even though a packet is received at the node from the network 14 (via the link 20) the virtual interface 24, may drop received packets, such as if more packets are received than can be buffered without causing bluffer bloat. Similarly, dynamic traffic controller 26 can control the congestion management function of the virtual interface 24 to drop packets (e.g., low priority packets) that are being transmitted from the node to the network 14 via the link 20 if the data packets to be transmitted exceed the quantity of packets that can be buffered without creating buffer bloat.

FIG. 2 depicts an example of a node 50 connected between a wide area network (WAN) 52 and a plurality of local area networks (LANs) 54, demonstrated as LAN1, LAN2 through LAN N, where N is a positive integer greater than 1. For purposes of simplification, corresponding links (e.g., NICs) have been omitted from FIG. 2, but would exist as part of the node 50 to physically connect to and communicate via each of the networks 52 and 54. In this example, the node 50 includes a receive (RX) virtual interface 56 and a transmit (TX) virtual interface 58. The receive virtual interface 56 is connected to receive incoming data traffic from the WAN 52 and provide streamlined data traffic to the local area networks 54. The transmit virtual interface 58 is connected to receive egress data traffic from the plurality of local area networks 54 and provide streamlined transmit traffic to the WAN 52.

Each of the receive virtual interface 56 and transmit virtual interface 58 is implemented similarly to the virtual interface 24 of FIG. 1, each controlling unidirectional data traffic through the node 50. Specifically, the receive virtual interface 56 executes receive streamlining on data packets received from the WAN 52 and provides the streamlined data traffic to each of the LANS 54. The receive streamlining establishes a priority of the data packets received from the WAN 52 based on prioritization rules. The receive streamlining also controls congestion of the data traffic received from the WAN by adjusting a rate limit of the receive virtual interface 56 based on a measure of bandwidth for the data traffic received at the node 50 from the WAN 52. The transmit virtual interface 58 executes transmit streamlining on the data packets being transmitted from the node 50 to the WAN 52 for data traffic provided by the LANs 54 to the WAN 52. The transmit virtual interface employs a prioritization method to establish a priority for sending the data packets to the WAN 52 based on the prioritization rules. The transmit virtual interface 58 also implements congestion management to control congestion of the data traffic that is transmitted from the node to the WAN 52 by adjusting a transmit rate limit of the virtual interface 58 based on a measure of bandwidth for the data traffic between the node 50 and the WAN 52. Thus, the node is configured to implement both transmit and receive streamlining on data packets that are communicated between each virtual interface 56, 58 and the WAN 52.

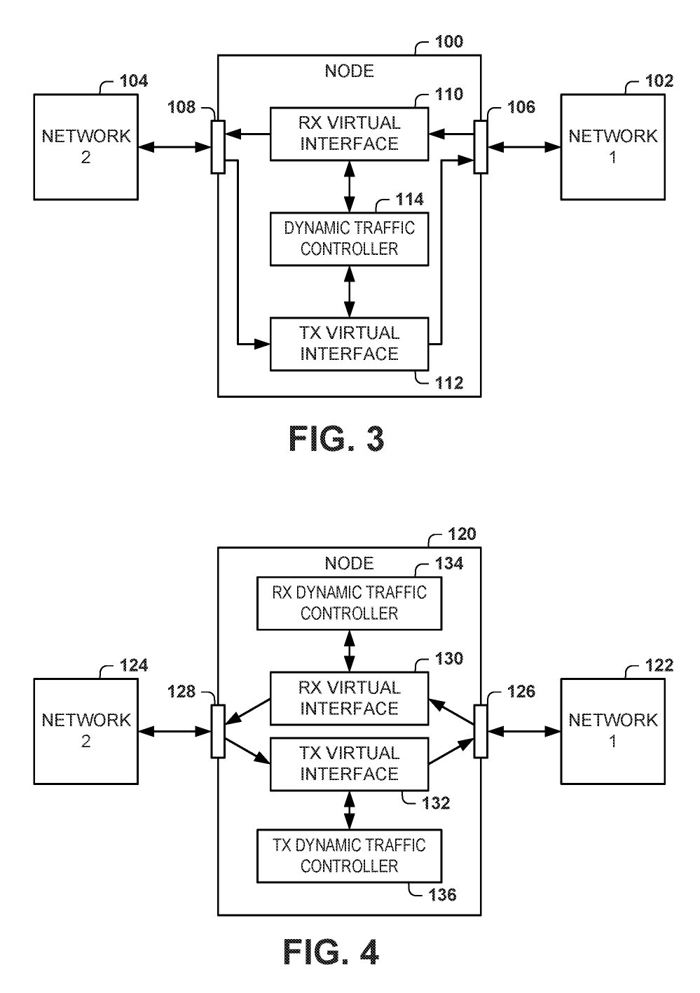

FIGS. 3 and 4 illustrate different example configurations that can be implemented for a node (e.g., node 10 or node 50) 100, 120. In the example of FIG. 3, the node 100 is connected in a network path between a first network 102 and a second network 104. The node 100 includes a link 106 connected to network 102 and another link 108 connected to the other network 104. As disclosed herein, there can be any number of respective first and second networks 102 and 104, and each collection of networks itself can constitute a network.

In the example of FIG. 3, the node 100 includes a receive virtual interface 110 connected between the links 106 and 108 to apply streamlining to data traffic received from the first network 102 via the link 106. The node 100 also includes a transmit virtual interface 112 connected between links 108 and 106 to apply transmit streamlining to data traffic received from the network 104 via link 108 before it is sent to the network 102 through the node 100. In this example, a given instance of dynamic traffic controller 114 controls both the receive virtual interface 110 and the transmit virtual interface 112 to perform streamlining by executing prioritization and congestion management functions. Thus the dynamic traffic controller 114 coordinates the receive and transmit streamlining operations that are performed with respect to the data traffic that is received from and sent to the network 102. Thus, like the other examples disclosed herein, each virtual interface 110 and 112 operates on the data traffic that is communicated between the virtual interface 110, 112 and a given network 102.

FIG. 4 depicts another example of a node (e.g., corresponding to the node 10 or 50) 120 connected in a network path between networks 122 and 124. The node 120 includes a link 126 connected to the network 122 and another link 128 connected between the node 120 and the network 124. In the example of FIG. 4, the node 120 includes a receive virtual interface 130 and a transmit virtual interface 132, each connected between the respective links 126 and 128. The receive virtual interface 130 is configured to apply receive streamlining to data packets received from the network 122 and provide streamlined data to the network 124 via link 128. The transmit virtual interface 132 is configured to apply transmit streamlining to data traffic from the network 124 that is sent to the network 122 via the link 126. In the example of FIG. 4, the node 120 includes a receive dynamic traffic controller 134 that controls receive streamlining performed by the receive virtual interface 130 and a transmit dynamic controller 136 that controls transmit streamlining implemented by the transmit virtual interface 132. Each of the dynamic traffic controllers 134 and 136 can be implemented as a respective instance of a dynamic traffic controller object that is associated with a respective unidirectional flow of data traffic with respect to the node 120 and the network 122. Within the node 120, the dynamic traffic controllers 134 and 136 (or higher level controls) can communicate to coordinate the respective streamlining functions that are performed with respect to the data traffic communicated between the node 120 and the network 122. For example, rate limiting operation that is implemented in each virtual interface 130 and 132 can be controlled in a defined order (e.g., alternating) so that the resulting effect of receive and transmit streamlining on the quality and bandwidth of network data traffic communicated between the node 120 and the network 122 is cooperative in nature.

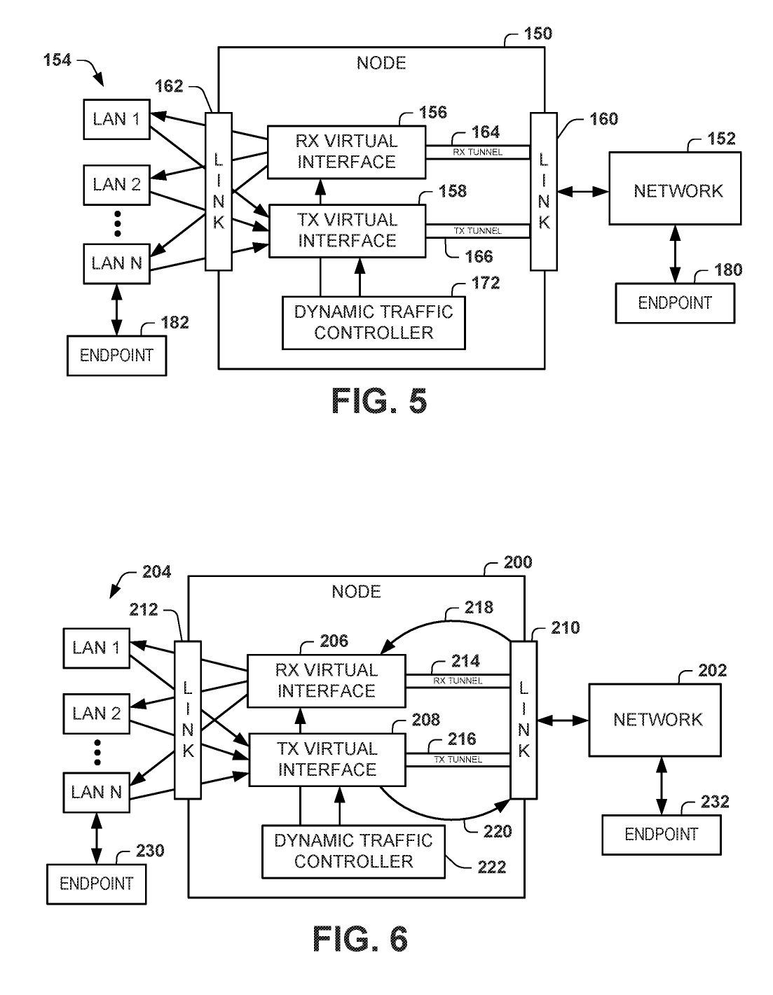

FIG. 5 depicts an example of a node 150 connected between networks 152 and 154 to perform receive streamlining and transmit streamlining to tunnel data traffic. The node 150 includes a receive virtual interface 156 and a transmit virtual interface 158 between respective network links 160 and 162 to perform streamlining on ingress and egress data traffic, respectively. For example, each of the links 160 and 162 includes one more ports for receiving ingress traffic at the node and one or more other ports for sending egress traffic from the node. A receive tunnel 164 connects the receive virtual interface with a location in the network 152, and a transmit tunnel 166 connects the transmit virtual interface with the same location. The far end location of each tunnel 164, 166 in the network 152 corresponds to a remote endpoint 180, such as user device, another node or another type of endpoint. Thus, each tunnel provides a logical connection between each virtual interface 156, 158 and the remote endpoint 180 residing in the first network 152, in which the tunnel encapsulates the communication of the data traffic between the virtual interface and such remote endpoint via which data traffic may be sent to and from one or more other endpoints 182 residing in one of the other networks 154.

In the example of FIG. 5, the receive tunnel 164 encapsulates receive (ingress) data packets from the network 152 with a new header that specifies a destination address of the node 150, such that each receive data packet from the network 152 is routed to the node 150 before going to its ultimate destination located in the one or more of the networks 154. The transmit tunnel 166 encapsulates transmit (egress) from the node to the network 152 with a new header that specifies a destination address of a predetermined location in the network 152. A dynamic traffic controller 172 controls each of the receive and transmit virtual interfaces 156 and 158 to execute prioritization method and congestion management to apply streamlining to data packets that are received by the node or transmitted from the node.

The tunnels 164 and 166 thus provide a virtual point-to-point link layer connection between endpoint 180 virtual interfaces 156 and 158, which virtual link layer connection includes the node 150 and a predetermined location in the network 152. In some examples, the tunnels implement secure (e.g., OpenVPN and IPsec) tunneling to provide for encrypted communication of the data packets between endpoints. In other examples, a tunnel can communicate data without encryption and, in some examples, the applications communicating can implement encryption for the packets that are communicated via the tunnels. As yet another example, encryption can be selectively activated and deactivated across respective tunnels based on the type of traffic or in response to a user input. In either case, the performance of the traffic communicated via the tunnel depends on the network link(s) between tunnel endpoints.

By way of further example, the receive tunnel 164 can be created for inbound data traffic to the node via the link 160 from the far end location (e.g., a node or other device) in the network 152. Similarly, the transmit tunnel 166 is created for transmitting egress traffic from the node 150 via the link 160 to the far end location. As described herein, the node resides in a path of data traffic between the endpoint (a software application and/or device) 180 that resides in or is connected to the network 152 and another endpoint (software application and/or device) 182 that resides in or is connected to the network 154. The actual path through each of the networks 152 and 154 to the endpoints therein remains under control of one or more service providers that implement the respective networks, which further can involve network peering (e.g., at peering points) to enable inter-network routing among such service providers. However, from the perspective of the node 150, a logical tunnel 164, 166 is established for receiving and transmitting data traffic via the link 160 with respect to the far endpoint 180 in network 152. The receive and transmit tunnels 164 and 166 also reside in the same path of data traffic to facilitate transport of ingress and egress data packets, as disclosed herein. Thus, other than using a link for receiving/transmitting data packets, the actual physical data path for packets through the network 152 is outside of the control of the node 150.

As one example, the node 150 is implemented at or near a digital subscriber line access multiplexer (DSLAM) or cable headend. The node 150 thus includes an instance of a virtual interface (e.g., at least a receive virtual interface or both receive and transmit virtual interfaces) to perform streamlining of data traffic for each of one or more premises in the network 154 that are users/customers that access the network 152 via the DSLAM or headend. That is, a given node 150 can include multiple instances of virtual interfaces, each implementing streamlining to data traffic that is communicated over a respective tunnel that encapsulates the data traffic for each premise. Each premise may include one or more devices in the network 154 that are connected to the node, which provides access to the other network 152.

FIG. 6 depicts an example of a node 200 connected between networks 202 and 204. Similar to the example of FIG. 5 the node 200 includes a receive virtual interface 206 and a transmit virtual interface 208 configured to perform receive streamlining and transmit streamlining to tunnel data traffic 214 and 216. Each of the receive and transmit virtual interfaces 206 and 208 is connected between network links 210 and 212. Additionally, the receive and transmit virtual interfaces 206 and 208 perform receive and transmit streamlining with respect to non-tunnel data traffic 218 and 220 that bypasses the tunnels 214 and 216. Specifically, the bypass traffic 218 corresponds to non-tunnel data traffic that is communicated from the network 202 through the node for an endpoint 230 in the network 204 and bypass traffic 220 corresponds to non-tunnel data traffic that is being transmitted to one or more endpoints 232 in the network 202. To preclude streamlining from being applied to data traffic, if desired, the bypass path carrying non-tunneled data packets may bypass the virtual interface, e.g., be routed directly between links 210 and 212.

Referring back to the example of FIG. 5, streamlining is applied only to data traffic that is communicated through the tunnel, while other data traffic (like bypass traffic—not shown in FIG. 5) may be routed through the node without streamlining. In contrast, the node 200 in FIG. 6 is configured to apply streamlining to both tunnel traffic 214 and 216 and bypass traffic 218 and 220 by routing all data traffic, which may include any number of tunnels and paths of non-tunneled (bypass) traffic, through the virtual interfaces 206 and 208. As mentioned, streamlining may be applied in one direction or both directions of the virtual interface. In examples where streamlining is applied to both directions, the node 200, may include a separate virtual interface for each direction, as shown in FIG. 6. In other examples, a single virtual interface can be implemented to apply streamlining for both receive and transmit directions with respect to a given network (e.g., network 202).

For example, the receive virtual interface 206 applies streamlining to the data traffic received from the first network 202 via the first link 210, including selected data traffic that is communicated via the tunnel 214 and the data traffic that is communicated through the bypass path 218. The transmit virtual interface 206 applies streamlining to the data traffic being transmitted to the first network 202 via the first link 210, including selected data traffic that is communicated via the tunnel 216 and the data traffic that is communicated through the bypass path 220. As a result, only selected data traffic that is communicated through the node is routed through a tunnel, but all traffic is streamlined as disclosed herein. A dynamic traffic controller 222 controls each of the receive and transmit virtual interfaces 206 and 208 to execute its streamlining functions on the data packets communicated between the node 200 and the first network 202 via the link 210 by prioritizing the data packets based on the prioritization rules. The dynamic traffic controller 222 further controls the virtual interfaces 206 and 208 to perform congestion management by adjusting a rate limit of the virtual interface for the data traffic that is being communicated between the node to the network 202 based on the measure of bandwidth for the network data traffic.

FIG. 7 depicts an example of a node 300 that that is implemented as a computing device that includes a processor 302 and memory 304. The processor 302 accesses the code stored in memory and executes it (e.g., of a computing device) to apply streamlining to network data traffic 306. The code may be executed directly on the node or it may execute in a virtual machine, which may reside in the node and/or another device (e.g., in a computing cloud). For instance, the code may be executed by the processor 302 to implement receive streamlining or both receive and transmit streamlining on data packets 308 that are communicated between the node and a given network. The node 300 thus includes links (e.g., network interface and associated circuitry—not shown in FIG. 7) to access and process data packets (e.g., physical and data link layer functionality) for the given network and one or more other networks, as disclosed herein.

As one example, the node 300 resides within a site (or premise) that is connected to a corresponding network, such as a WAN (e.g., the internet). The site (or premise) itself includes one or more local area networks via which various local endpoints (e.g., devices, applications and/or services) are connected to communicate. Such local endpoints can also access remote endpoints (e.g., device, applications and/or services) via the node that is connected to WAN. In other examples, the node may be connected at other network locations, such as where a bottleneck may occur, such as at peering points, internet backbones or the like

In the example of FIG. 7, for sake of consistency, the streamlining applied to data traffic 306 is described as receive streamlining applied to ingress data packets received from a given network; however, the code stored in the memory 304 is equally applicable to apply transmit streamlining to egress data packets 308 before being transmitted to the given network, as also disclosed herein. The data packets 308 of the traffic 306 being streamlined are placed (e.g., by the network link/interface circuitry) into an IP stack 310 of the node. There may be transmit and receive stacks in the node when configured to execute both transmit and receive streamlining.

The node includes a dynamic traffic controller 312 that controls a virtual interface 314 to apply streamlining to the data packets 308 in the stack 310. The dynamic traffic controller 312 can be implemented as kernel level executable instructions in the operating system of the node, can be distributed within the operating system kernel and user application space or be implemented entirely within user application space (outside of the operating system). The user-level applications may be within the same processor as executing the OS kernel. In other examples, the application may be executed by a different processor, such as residing within a network interface or virtualized in another device (e.g., in a computing cloud).

The dynamic traffic controller 312 includes a prioritization method 316 and congestion management control 318 that cooperate to control the virtual interface 314 and apply streamlining (receive or transmit streamlining) to the data packets 308. The prioritization method 316 prioritizes each of the data packets 308 and places the prioritized packets in respective queues 320 of the virtual interface 314 based on prioritization rules 322 stored in the memory 304. The prioritization rules 322 can be preprogrammed and/or set in response to a user input instruction received via a user interface. In response to user instructions entered via the user interface, for example, the rules can define data and metadata to categorize and queue the data packets in the virtual interface 314.

The congestion management control 318 controls congestion of the data traffic by adjusting a rate limit of the virtual interface for the data traffic based on a measure of bandwidth for the data traffic. As part of receive streamlining, for example, the congestion management control 318 may control congestion of data traffic that is received from a given network by adjusting a rate limit for the data traffic being received based on measured bandwidth for the given network. Additionally, the congestion management control 318 may adjust the rate limit for the data traffic that is transmitted to the given network based on the bandwidth for the given network. In this way, the congestion management control 318 controls the throughput of data traffic that is communicated on the path between networks where the node resides.

The virtual interface 314 can include any number of two or more queues 320, including at least a high priority queue and a lower priority queue. In an example where the dynamic traffic controller 312 implements receive streamlining for data received from more than one network connection, the virtual interface 314 can include a plurality of receive queues for receiving data traffic from each network connection. In an example where the dynamic traffic controller also implements transmit streamlining for data being transmitted to more than one network connection, the virtual interface can include a plurality of transmit queues for sending data to each network connection. Examples of the type of packets to be placed in a high priority one of the queues 320 may include interactive voice, interactive video applications or other data traffic deemed by a user to be time-sensitive compared to other data traffic.

The prioritization method 316 includes a packet evaluator 324, a packet categorizer 326 and a priority queuing control 328 that cooperate to prioritize the data packets 308 being streamlined. The packet evaluator 324 executes instructions to evaluate certain packet information for each packet 308 in the stack 310, which information may be different for different types of packets and depending on the prioritization rules 322. The packet categorizer 326 uses the evaluation results (evaluation data) from the packet evaluator 324 to categorize the packet according to a type and/or behavior of network data traffic to which the packet belongs. The priority queuing control 328 selectively places each data packet in one of the plurality of queues 320 depending on the priority of the packet determined from its categorization.

As one example, the packet evaluator 324 evaluates IP headers in the packet 308 to determine the protocol (e.g., TCP or UDP) and, in some circumstances, the determined type of protocol further can be utilized by the packet evaluator to trigger further packet evaluation (e.g., deeper inspection) by the packet evaluator that depends on the determined type of protocol. For instance, in response to detecting a UDP packet, the packet evaluator 324 can further inspect contents of the packet to identify the port number, and the packet categorizer 326 can categorize the UDP packet with a particular packet categorization based upon its identified port number. In another example, the packet categorizer 326 can determine a category or classification to be utilized for a UDP packet based on evaluation of the packet's differentiated services code point (DSCP) value. The packet categorizer 326 can add metadata (kernel-level or application-level metadata) to the packet that specifies the type of traffic determined based on the packet evaluator 324 and rules 322.

As yet another example, the packet evaluator 324 is programmed to evaluate each data packet to determine a behavior of the data traffic based on a session tuple, such as can include two or more of a source IP address, a source port, a destination IP address, a destination port, a DNS request (e.g., DNS query), a network protocol and a differentiated services code. The packet categorizer 326 thus can classify each packet based on the session tuple determined by the packet evaluator 324 for each respective packet.

As another example, in response to the packet evaluator 324 detecting the data packet is TCP data, the packet evaluator 324 can look at the payload to determine if it is web traffic and, if so, which particular application may have sent it or to which application it is being sent. For example, certain data from applications can be specified as high priority data in the corresponding prioritization rules 322. As mentioned, for example, the prioritization rules 322 can be programmed in response to a user input entered via a graphical user interface (e.g., a GUI implemented as part of a control service). The prioritization rules 322 thus can be programmed in response to the user input, which rules can be translated to corresponding instructions executed by the dynamic traffic controller 312 to control streamlining by prioritizing routing of each of the data packets from the node. Based on the evaluation of each data packet and prioritization rules 322, the packet categorizer 326 determines corresponding categorizations that are be assigned to each of the packets to enable prioritized routing.

The packet categorizer 326 uses the packet information from the packet evaluator 324 to categorize the packet according to the type and/or behavior of network data traffic to which the packet belongs. By way of example, the packet categorizer 326 tags (marks) each of the packets, such as by adding priority metadata to each packet, specifying the categorization (priority class) for each respective packet based on the evaluation performed by packet evaluator 324. The priority metadata facilitates queuing of marked packets as well as enables upstream analysis of network quality and/or capacity, such as may be implemented by a corresponding network analysis function 330. For example, the network connection for high priority data packets can be managed dynamically by the dynamical traffic controller 312 to help improve and maintain quality of service for time-sensitive network traffic that is received and/or transmitted based on streamlining the data traffic between the node 300 and the network.

The priority queuing control 328 thus can employ the priority metadata, describing one or more categorizations of the packet, to control into which of the plurality of queues 320 each data packet is placed. For example, the queues 320 of the virtual interface are receive queues and the virtual interface applies receive streamlining on the data traffic received from a given network and then sends the packets out along the data path in the same direction that it was received (e.g., to the next network). For the transmit streamlining example, the virtual interface 314 applies transmit streamlining on the data traffic that is to be transmitted to the network and then sends the packets out along the data path in the same direction that it was received (e.g., to the next network).

In some examples, the queuing control 328 can place the actual data packet from the IP stack 310 into its respective queues 320 as prioritized based upon the categorization determined for each respective packet. In other examples, each of the queues 320 can be populated with pointers (e.g., data identifying physical memory address locations) to the data packet within the IP stack 310 to enable the network link to retrieve and send out each of the respective data packets from the IP stack based on the pointers stored into the queues identifying the priority of the data packets. For instance, the pointers can identify the headers, payload and other portions of each respective data packet to enable appropriate processing of each data packet by the network interface of each respective data packet.

As mentioned, the dynamic traffic controller 312 performs the streamlining based on network characteristics determined by the network analysis function 330. The network analysis 330 may be implemented within the node and/or it may be distributed to other resources in the network path. The network analysis may include a capacity calculator 332, a load evaluator 334 and a quality calculator 336 to quantify different network characteristics relevant to streamlining that is performed by the dynamic traffic controller 312.

The load evaluator 334 is programmed to evaluate and determine indication of network load (aggregate throughput of data traffic) that is being sent over each network connection for which streamlining is being performed, including the network to which receive streamlining is applied or the given network connection to which both receive and transmit streamlining. By way of example, a service provider usually specifies a maximum bandwidth for a given user's connection. This may be specified in a contract (service level agreement) or published online or elsewhere. The maximum available bandwidth thus can be provided as input data, specifying a static capacity to the capacity calculator 332 of network analysis 330, to compute a corresponding static ratio of relative performance for each network connection for which streamlining is being performed. The network analysis 330 can compute respective static performance ratios for a given network according to its fractional part of the aggregate bandwidth.

As another example, the capacity calculator 332 can determine a dynamic capacity estimate for each of the network connections. The dynamic capacity estimate provides an indication of available capacity for a given network determined from dynamic measurements of the network instead of a static bandwidth specified for the network. For instance, the capacity calculator 332 is programmed to compute an estimate of capacity based on the maximum throughput measured over a given network. This maximum throughput may be computed over an entire history of measurements of a given network, measurements over a specific period of time (e.g., a most recent time period), measurements since a specific event (e.g., a change in network configuration specified by user input or detected by capacity calculator 332), or a combination of these methods. In examples when a dynamic capacity estimate is not known or cannot yet be determined (e.g., because insufficient measurements are available), a static capacity can be used. Alternatively, a dynamic capacity estimate can be determined (by capacity calculator 332) based on the maximum throughput measured with good quality. The dynamic traffic controller 312 can thus utilize either or both static and/or dynamic measures of network capacity to implement streamlining, as disclosed herein. As an example, the capacity calculator 332 obtains a measure of throughput (from load evaluator 334) for a receive path and a measure of quality (a determined quality metric) for the path, and then estimates capacity as the throughput at or near the boundary between good and bad quality (the quality boundary).

The quality calculator 336 can determine an indication of network quality based on passive measurements, active measurements or a combination of passive and active measurements for each of the available networks. As used herein, active measurements involve creating additional traffic that is sent in the outbound traffic via one or more of the networks for the purpose of making such measurements, whereas passive measurements evaluate measurements made on existing traffic being sent out of or received by the node via a given network connection. Examples of some types of quality measurements that can be implemented by the quality calculator 336 include network failure, local path sojourn time and jitter.

By way of further example, the quality calculator 336 can compute jitter as an average of the deviation from the network mean packet latency. As a further example, the jitter calculation performed by quality calculator 336 can be implemented according to the approach disclosed in real time control protocol (RTCP). An active jitter measurements can be implemented by having another node or other endpoint in a remote far end network location (e.g., recipient) compute jitter for high priority packets sent from the node via a transmit path to the network (via transmit streamlining). The recipient (node or other endpoint) can transmit an indication of the computed jitter back to the node. Alternatively, the timing data used to determine jitter itself can be sent back to the sender, which can be programmed compute the corresponding jitter. In another examples, a packet sent from the node's network link (via transmit streamlining) can be sent to an address location of the node associated with its receive streamlining path to compute an indication of jitter.

As another example, the quality calculator 336 (or other component) can send an ICMP request (e.g., echo requests (pings) or ICMP Timestamp Requests) to a predetermined location/address in the given network. The ICMP requests provide round-trip latencies, which can be used by the dynamic traffic controller as the measure of quality, although other quality metrics may be used.

The congestion management control 318 employs the measure of quality and capacity estimates from the network analysis 330 to identify and, in turn, improve quality of traffic that is streamlined by the virtual interface (e.g., receive streamlining or both receive and transmit streamlining) over the given network connection. For the example of transmit streamlining, the quality issue may pertain to quality of traffic within an enterprise site or site device where the data traffic originates. For the example of receive streamlining, the issue can relate to traffic flow in a WAN backbone or within a cloud data center from which the data traffic is received at the node 300.

The congestion management control 318 of the dynamic traffic controller 312 thus is programmed to control the virtual interface 314 to set a rate limit 340 that establishes a throughput for the data packets 308 that propagate through the node 300 based on a measure of bandwidth for the data traffic at good quality (quality that exceeds a predetermined quality level). In some examples, the congestion management control 318 uses the magnitude of individual latencies (e.g., determined by quality calculator 336) to make intermediate rate limit adjustments for the virtual interface 314 when controlling quality of data traffic. The rate limit 340 controls the rate that packets are routed, in aggregate, from the queues to the network connection. In response to detecting congestion corresponding to a decrease in network traffic quality, for example, the congestion management control 318 of controller 312 reduces the rate limit for the traffic through node. For example, the congestion management control 318 reduces the rate limit to be at about (or just below) the capacity estimate (determined by capacity calculator 332) of bottleneck of the external network path, which results in more efficient data traffic via the network path. The rate limit adjustments within the node 300 can be implemented as incremental adjustments or stepwise adjustments depending on the amount of congestion and the current estimate of capacity. A stable rate limit set by dynamic is a rate limit that produces the binary measure of good quality.

The congestion management control 318 controls the throughput of data traffic through each of the queues 320 according to the rate limit 340 and current estimate of capacity and quality (a capacity estimate at good quality). For the example of a high and low priority queue for a given network connection, the congestion management control 318 reduces the rate limit (at least initially) to decrease the throughput of data traffic only for the lower priority queue, while the throughput for data packets in the high priority queue is unaffected by the rate limit reduction. Thus, the high priority traffic is maintained at a desired high quality.

In some example situations, such as to meet the estimated capacity and/or avoid buffer bloat through the node, the congestion management control 318 controls the virtual interface to drop and discard one or more next packets from a given one of the plurality of queues 320 that are to be sent over a given network connection. This may include packets that have been successfully received from the given network, as in the case of receive streamlining. Alternatively, a packet may be discarded prior to transmission to the given network, as in the case of transmit streamlining. As mentioned, the packets discarded can be limited to low priority packets to ensure that higher priority traffic, which the queuing control placed in the high priority queue, remains at a desired high quality, as permitted by the capacity estimate.

It will be appreciated that for a given forward direction of streamlining, forward and opposite direction traffic may both contribute to current forward and opposite capacity. In some cases, a simple relationship between forward and opposite traffic can be determined by the capacity calculator 332 so that a single total bidirectional capacity is meaningful. For example, an ISP service of 100 Mbps may provide 100 Mbps downstream, 95 Mbps downstream and 5 Mbps upstream, or 90 Mbps downstream and 10 Mbps upstream. In other cases, the relationship between upstream and downstream traffic and capacity is more complex than a simple total bidirectional capacity and may be represented as a function or matrix. For example, ISP service of 30 Mbps may provide 30 Mbps downstream, 25 Mbps downstream and 1 Mbps upstream, 20 Mbps downstream and 2 Mbps upstream, or 3 Mbps upstream. The relationship between forward and opposite capacity generally depends on various physical properties of the ISP link technology (e.g., DSL, cable, fiber etc.) and ISP policies. Thus, the capacity calculator 332 can be programmed to determine a functional relationship between forward and opposite capacity measures. The relationship may be a simple value of aggregate (forward and opposite) capacity or a more complex relationship, such as may be represented as a matrix of a plurality of measurements and/or as a mathematical or statistical function. The congestion control 318 can in turn set the rate limit in the forward (and/or opposite direction) based on the relationship between the forward and opposite capacity.

While the above examples describe two priority levels, high and low priority, the virtual interface 314 can implement any number of priority levels, each having a respective queue 320. Each priority level of traffic (and thus each queue) may have a predetermined minimum throughput level (e.g., a percentage of the total rate limit for a network connection), and the congestion management control 318 may reduce the actual rate limit of the lower priority traffic until it reaches the minimum allowed, and then adjust the rate limit of a next higher priority level until it reaches its minimum rate limit, with the highest priority level traffic being the last to be reduced. This reduction in throughput may result in such lower priority traffic being dropped; however, this minimum throughput helps prevents lower priority traffic from being starved by high rates of higher priority traffic.

In some protocols (e.g., ACK-based protocols like TCP), when a packet is discarded by the congestion management control 318 of node 300, the node may refrain from providing feedback (e.g., an acknowledgement (ACK)) or provide feedback (e.g., a negative ACK or NACK) to the sender to indicate such packet was not received. Such feedback facilitates transport protocol functions of the first network to adjust the bandwidth and resend packets as may be needed.

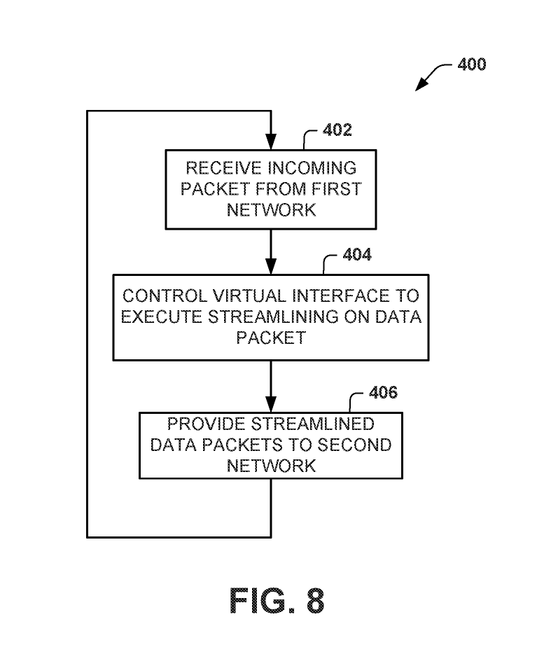

In view of the structural and functional features described above, certain methods will be better appreciated with reference to FIG. 8. It is to be understood and appreciated that the illustrated actions, in other embodiments, may occur in different orders or concurrently with other actions. Moreover, not all features illustrated in FIG. 8 may be required to implement a method. It is to be further understood that the following method can be implemented in hardware (e.g., one or more processors, such as in a computer or computers), software (e.g., stored in a computer readable medium or as executable instructions running on one or more processors), or as a combination of hardware and software.

FIG. 8 is a flow diagram depicting an example of a method 400 to apply streamlining to network data traffic at a node. As disclosed herein, the streamlining can be applied data traffic that is received at the node from a given network or, in other examples, it may be applied to both data traffic that is received at the node from the given network and data traffic transmitted to the given network from the node.

At 402, the method includes receiving, at a given node (e.g., node 10, 50, 100, 120, 150, 200, 300) data traffic from a first network via a first link of the node that is connected to the first network. The node thus resides in a communications path of the bidirectional data traffic propagating between the first network and another (e.g., a second) network. In some examples, the node is located at or near a bottleneck occurs for traffic communicated between the first and second networks. For instance, the first network is a WAN and the link between the WAN and the node is a data bottleneck, and the second network is a LAN and/or an internet backbone (e.g., of an internet service provider), such as a peering point or other exchange point between internet networks.

At 404, the method includes controlling a virtual interface of the node to execute receive streamlining on each of the data packets in the data traffic received from the first network. The virtual interface is coupled between the first link and another link that is connected to the second network. The receive streamlining is applied to the data traffic to establish a priority for data packets received from the first network (e.g., by prioritization method 316) based on prioritization rules (e.g., rules 322). The receive streamlining also is applied to control congestion of the data traffic (e.g., by congestion management function 318) received from the first network by adjusting a rate limit of the virtual interface for the data traffic received from the first network via the first link based on a measure of bandwidth for the first network. At 406, the streamlined data packets are provided from the virtual interface to the second network via the second link.

As a further example, the priority that is established as part of the streamlining of the data packets received from the first network (at 404) may include categorizing (e.g., by categorizer 326) each packet in the data traffic that is received from the first network based on an evaluation of each packet (e.g., by packet evaluator 324) with respect to the prioritization rules (e.g., rules 322). Each packet is placed (e.g., by priority queuing control 328) in one of a plurality of receive queues (e.g., queues 320) associated with the first network according to the categorization of each respective packet and an estimated capacity for the data traffic communicated between the node and the first network. The packets are sent from the virtual interface to the second network via a respective network connection of the second link according to a priority of the respective receive queue into which each packet is placed, such that the virtual interface controls the throughput of data traffic to the second network (e.g., by streamlining data traffic received from the first network) based on the estimated capacity for the connection between the first network and the node.

As a still further example, each of the plurality of receive queues (e.g., queues 320) associated with the first network connection is assigned different priority (e.g., prioritization rules 322) for sending different priority data traffic from virtual interface (e.g., as categorized by categorizer 326). In this example, a rate limit is set for the data traffic that is received from first network (e.g., by rate limit component 340) based on a current estimated capacity for the data traffic between the node and the first network. Throughput of data traffic is controlled (e.g., by congestion management control 318) for each of the plurality of queues of the first network connection, such as by reducing throughput of traffic for at least one lower priority queue of the given connection if an aggregate throughput for the given network connection exceeds the rate limit thereof while maintaining or increasing throughput of at least one higher priority queue of the given network connection. In some examples, the method 400 includes dropping a next packet from a given one of the plurality of the receive queues (e.g., queues 320) to meet the estimated capacity and thereby facilitate transport protocol functions of the first network to adjust the bandwidth of the network.

As yet another example, the method 400 may further include establishing a tunnel (e.g., tunnel 164, 214) between the virtual interface and a remote endpoint via the first network. The data traffic communicated between the virtual interface and the remote endpoint via the first network is encapsulated within the tunnel. The receive streamlining at 404 (e.g., including prioritization and congestion control) is performed on tunnel data traffic received from the remote endpoint via the first network. In some examples, a bypass path (e.g., path 218) resides within the node and provides a connection between the virtual interface and the first link to bypass the tunnel for selected data traffic received from the first network. Thus, in some examples, not all traffic received from or sent to the first network needs to be sent via the tunnel. In such examples, the bypass traffic is communicated between endpoints in the first and second networks through the node without being encapsulated in the tunnel. Since both the bypass traffic and the tunnel traffic flow through the virtual interface, the virtual interface can be configured to apply the streamlining to the data traffic received from the first network via the first link, including both the selected data traffic that is communicated via the tunnel and the data traffic that is communicated through the bypass path.

While the method 400 is described above generally with respect to receive streamlining on data traffic received from the first network, each of the actions at 402-406 can be performed by a single node device to additionally implement transmit streamlining that is applied to data traffic being sent from the second network to the first network via such node. In this example, the method can perform streamlining for bidirectional paths of data traffic that are communicated through the node. For example, the method includes receiving, at the node, data traffic from the second network via the second link. The method also includes controlling the virtual interface to execute transmit streamlining on data packets received at the node from the second network. Similar to receive streamlining, the transmit streamlining establishes a priority for sending the transmit streamlined data packets received from the second network to the first network based on the prioritization rules. The transmit streamlining also controls congestion of the data traffic received from the second network by adjusting a transmit rate limit of the virtual interface for the data packets being transmitted to the first network via the first link based on a measure of bandwidth for the first network. The streamlined data packets are transmitted to the first network via the first link based on the transmit streamlining that is performed. Such transmit streamlining further may include the actions 402-406 as well as the additional functionality described above with respect to the receive streamlining and as disclosed elsewhere herein.

As will be appreciated by those skilled in the art, portions of the systems and methods disclosed herein may be embodied as a method, data processing system, or computer program product (e.g., a non-transitory computer readable medium having instructions executable by a processor). Accordingly, these portions of the invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments are disclosed herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in a non-transitory computer-readable medium that can direct a computer or other programmable data processing apparatus (e.g., one or more processing core) to function in a particular manner, such that the instructions stored in the computer-readable medium result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks or the associated description.

What are disclosed herein are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims.

As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A node, comprising:
a first link to connect a first network;
a second link to connect to a second network;
a virtual interface coupled between the first link and the second link and residing in a communications path for data traffic between the first network and the second network; and
an instance of a dynamic traffic controller that controls the virtual interface to execute receive streamlining on data packets received from the first network and provide streamlined data packets to the second network via the second link based on the receive streamlining, the receive streamlining establishes a priority for receiving the data packets from the first network for sending the received data packets based on prioritization rules and controls congestion of the data traffic received from the first network by adjusting a rate limit of the virtual interface for the data traffic received from the first network based on a measure of bandwidth for the first network.

2. The node of claim 1, further comprising a tunnel between the virtual interface and a remote endpoint residing in the first network, the tunnel encapsulating communication of the data traffic between the virtual interface and the remote endpoint via the first network.

3. The node of claim 2, further comprising a bypass path within the node between the virtual interface and the first link that bypasses the tunnel for selected data traffic.

4. The node of claim 3, wherein the virtual interface applies the receive streamlining to the data traffic received from the first network via the first link, including the selected data traffic that is communicated via the tunnel and the data traffic that is communicated through the bypass path.

5. The node of claim 1, wherein the first network comprises a wide area network and the link between the wide area network and the node is a data bottleneck, and the second network comprises at least one local area network or an internet backbone.

6. The node of claim 1, wherein the dynamic traffic controller executes a prioritization method to determine the priority for the data packets received from the first network, the prioritization method comprising:
categorizing each packet in the data traffic that is received from the first network based on an evaluation of each packet with respect to the prioritization rules;
placing each packet in one of a plurality of receive queues associated with the first network according to the categorization of each respective packet and an estimated capacity for the data traffic communicated between the node and the first network; and
sending the packets from the virtual interface to the second network via a respective network connection of the second link according to a priority of the respective receive queue into which each packet is placed, such that the virtual interface controls transmission of data traffic to the second network based on the estimated capacity for the connection between the first network and the node.

7. The node of claim 6, wherein each of the plurality of receive queues associated with the first network connection is assigned different priority for sending different priority egress data traffic from virtual interface, the dynamic traffic controller executing a congestion management control method comprising:
setting a rate limit for the data traffic that is received from the first network based on a current estimated capacity for the data traffic between the node and the first network; and
control throughput of data traffic for each of the plurality of queues of the first network connection by reducing throughput of traffic for at least one lower priority queue of the given connection if an aggregate throughput for the given network connection exceeds the rate limit thereof while maintaining throughput of at least one higher priority queue of the given network connection.

8. The node of claim 6, wherein the prioritization method further comprises dropping a next packet from a given one of the plurality of receive queues to meet the estimated capacity to facilitate transport protocol functions of the first network to adjust the bandwidth of the first network.

9. The node of claim 1, wherein the dynamic traffic controller controls one of the virtual interface or another virtual interface of the node to execute transmit streamlining on data packets received from the second network and transmit streamlined data packets to the first network via the first link based on the transmit streamlining, the transmit streamlining establishing a priority for sending the data packets received from the second network to the first network based on the prioritization rules and controls congestion of the data traffic received from the second network by adjusting a transmit rate limit of the virtual interface for the data traffic received from the second network based on the measure of bandwidth for the first network.

10. The node of claim 9, wherein the dynamic traffic controller executes a prioritization method to determine the priority for the data packets received from the first network and to determine the priority for the data packets received from the second network, the prioritization method comprising:
categorizing each packet of the data traffic based on an evaluation of each packet with respect to the prioritization rules;
placing each packet received from the first network in one of a plurality of receive queues according to the categorization of each respective packet and an estimated capacity for a connection to the first network;
placing each packet received from the second network in one of a plurality of transmit queues according to the categorization of each respective packet and an estimated capacity for the connection to the first network; and
sending the packets from the plurality of receive queues to the second network via a respective network connection in the second link according to a priority of the respective receive queue into which each packet is placed, such that the virtual interface transmits data packets from the node to the second network based on the estimated capacity for the connection to the first network; and
sending the packets from the plurality of transmit queues to the first network via a respective network connection in the first link according to a priority of the respective transmit queue into which each packet is placed, such that the virtual interface transmits data packets to the first network based on the estimated capacity for the connection to the first network.

11. The node of claim 10, wherein each of the plurality of receive queues associated with the first network connection is assigned different priority for sending different priority egress data traffic from virtual interface, the prioritization method further comprising:
setting a rate limit for the data traffic received from the first network based on a current estimated capacity for the data traffic between the node and the first network; and
controlling throughput of data traffic for each of the plurality of receive queues of the first network connection by reducing throughput of traffic for at least one lower priority queue of the given connection if an aggregate throughput for the given network connection exceeds the rate limit thereof while maintaining throughput of at least one higher priority queue of the first network connection.

12. The node of claim 1, wherein the virtual interface is a first virtual interface residing in the communications path for the data traffic from the first network to the first network, the node further comprising:
a second virtual interface coupled between the first link and the second link and residing in a communications path for the data traffic from the second network to the first network; and
one of the dynamic traffic controller or another instance of the dynamic traffic controller controls the second virtual interface to execute transmit streamlining on data packets received from the second network and provide streamlined data packets to the first network via the first link, the transmit streamlining establishing a priority for sending the data packets received from the second network to the first network based on the prioritization rules and controls congestion of the data traffic received from the second network by adjusting a rate limit of the second virtual interface for the data traffic that is transmitted to the first network based on a measure of bandwidth for the first network.

13. The node of claim 1, wherein the virtual interface and the dynamic traffic controller are executed on a virtual machine residing within the node and/or a computing cloud.

14. A method comprising:
receiving, at a node, data traffic from a first network via a first network connection of the node that is connected to the first network, the node residing in a communications path for the data traffic between the first network and a second network;
controlling a virtual interface of the node, which is coupled between the first network connection and a second network connection connected to the second network, to execute receive streamlining on each data packet in the data traffic received from the first network, the receive streamlining establishing a priority for sending the data packets received from the first network to the second network based on prioritization rules and controlling congestion of the data traffic received from the first network by adjusting a rate limit of the virtual interface for the data traffic received from the first network via the first network connection based on a measure of bandwidth for the first network connection; and
providing streamlined data packets from the virtual interface to the second network via the second network connection based on the receive streamlining.

15. The method of claim 14, further comprising:
establishing a tunnel between the virtual interface and a remote endpoint via the first network; and
encapsulating within the tunnel the data traffic communicated between the virtual interface and the remote endpoint via the first network, the receive streamlining being performed on tunnel data traffic received from the remote endpoint via the first network.

16. The method of claim 15, wherein a bypass path resides within the node between the virtual interface and the first network connection to bypass the tunnel for selected data traffic that is received via the first network, wherein the virtual interface applies the receive streamlining to the data traffic received from the first network via the first network connection, including the data traffic that is communicated via the tunnel and the selected data traffic that is communicated through the bypass path.

17. The method of claim 14, wherein the first network comprises a wide area network and a path between first network connection and the wide area network and the node is a data bottleneck, and the second network comprises at least one local area network or an internet backbone.

18. The method of claim 14, wherein determining the priority for the data packets received from the first network comprise:
categorizing each packet in the data traffic that is received from the first network based on an evaluation of each packet with respect to the prioritization rules;
placing each packet in one of a plurality of receive queues associated with the first network according to the categorization of each respective packet and an estimated capacity for the data traffic communicated between the node and the first network; and
sending the packets from the virtual interface to the second network via a respective network connection of the second network connection according to a priority of the respective receive queue into which each packet is placed, such that the virtual interface controls transmission of data traffic to the second network based on the estimated capacity for the data traffic communicated between the node and the first network.

19. The method of claim 18, wherein each of the plurality of receive queues associated with the first network connection is assigned different priority for sending different priority data traffic from virtual interface, the method further comprising:
setting a rate limit for the data traffic that is received from the first network based on a current estimated capacity for the data traffic between the node and the first network; and
controlling throughput of data traffic for each of the plurality of queues of the first network connection by reducing throughput of traffic for at least one lower priority queue of the given connection if an aggregate throughput for the given network connection exceeds the rate limit thereof while maintaining or increasing throughput of at least one higher priority queue of the given network connection.

20. The method of claim 19, wherein the method further comprises dropping a next packet from a given one of the plurality of the receive queues to meet the estimated capacity and thereby facilitate transport protocol functions of the first network to adjust the bandwidth of the first network.

21. The method of claim 14, further comprising:
receiving, at the node, data traffic from the second network via the second network connection;
controlling the virtual interface to execute transmit streamlining on data packets received at the node from the second network, the transmit streamlining establishing a priority for sending the transmit streamlined data packets received from the second network to the first network based on the prioritization rules and controls congestion of the data traffic received from the second network by adjusting a transmit rate limit of the virtual interface for the data packets being transmitted to the first network via the first network connection based on a measure of bandwidth for the first network; and
transmitting the streamlined data packets to the first network via the first network connection based on the transmit streamlining.

22. The method of claim 21, further comprising:
categorizing each packet of the data traffic based on an evaluation of each packet with respect to the prioritization rules;
placing each packet received from the first network in one of a plurality of receive queues according to the categorization of each respective packet and an estimated capacity for a network connection of the node to the first network;
placing each packet received from the second network in one of a plurality of transmit queues according to the categorization of each respective packet and an estimated capacity for the first network connection to the first network; and
sending the packets from the virtual interface to the second network via a respective network connection in the second network connection according to a priority of the respective receive queue into which each packet is placed, such that the virtual interface sends the streamlined data packets from the node to the second network based on the estimated capacity for the first network connection to the first network; and
sending the packets from the virtual interface to the first network via a respective network connection in the first network connection according to a priority of the respective transmit queue into which each packet is placed, such that the virtual interface sends the streamlined data packets to the first network based on the estimated capacity for the first network connection to the first network.

23. The method of claim 22, wherein each of the plurality of receive queues associated with the first network connection is assigned different priority for sending different priority egress data traffic from virtual interface, the prioritization method further comprising:
setting a rate limit for the data traffic received from the first network based on a current estimated capacity for the first network connection to the first network; and
controlling throughput of data traffic for each of the plurality of receive queues by reducing throughput of traffic for at least one lower priority receive queue if an aggregate throughput for the first network connection exceeds the rate limit thereof while maintaining throughput of at least one higher priority queue of the first network connection.
